(19) United States
(12) Patent Application Publication
(10) Pub. No.: US 2018/0368594 A1
(43) Pub. Date: Dec. 27, 2018

(54) FEEDING MAT

(71) Applicant: Admar International, Inc., Monroe, LA (US)

(72) Inventor: Nouri E. Hakim, Monroe, LA (US)

(21) Appl. No.: 16/119,466

(22) Filed: Aug. 31, 2018

Related U.S. Application Data
(63) Continuation of application No. PCT/US2017/046110, filed on Aug. 9, 2017.
(60) Provisional application No. 62/373,202, filed on Aug. 10, 2016.

(51) Int. Cl. A47G 19/10; F16B 47/00; A47G 23/03

(52) U.S. Cl. CPC A47G 19/10; A47G 23/0303; F16B 47/00

(57) ABSTRACT

A feeding mat and methods for its use are disclosed. In some embodiments, the feeding mat comprises a base having an upper surface, a lower surface, an inner region and an outer region. In some embodiments, an outer wall is integrally formed in the upper surface forming a dish suitable to contain a food product. In some embodiments, the inner region is essentially planar and forms a reference plane generally parallel to the flat surface. In some embodiments, the outer region has a slope with respect to the inner region and reference plane in the range of around 1.0° to 10.0°.

### CROSS REFERENCE TO RELATED APPLICATIONS

This application is a continuation of, and claims priority to, International Application No. PCT/US2017/046110, filed Aug. 9, 2017, which claims the benefit of U.S. Provisional Application No. 62/373,202, filed Aug. 10, 2016, all of which are incorporated herein by reference in their entirety for all purposes.

### FIELD OF THE DISCLOSURE

The present disclosure relates generally to consumer products directed to the parents and care givers of children and toddlers and, more particularly, to a feeding mat.

### BACKGROUND

As every parent and care giver of children knows, small children and toddlers tend not to have impeccable table manners and generally are messy eaters. Not infrequently, more food ends up on the table and surrounding area then is consumed by the toddler. One well-known solution is to put a placemat under the child's dinnerware such as a dish, bowl or plate. While the placemat will protect the table or other covered surface, a problem arises when the child inadvertently or intentionally tests the laws of gravity and sends the dinnerware flying, spilling food far and wide. To mitigate the effects of these exploratory acts on the part of the little tike, one proposed solution is to provide the dinnerware with a suction cup to hold the dinnerware to the table surface. While this solution tends to prevent flying dinnerware, it does not protect the table or surrounding area from spilled food. Other problems with this solution are that the suction cup is cumbersome, tends not to adhere sufficiently to a placemat and requires a special means of attaching the dinnerware. Another recent proposed solution is the EZPZ All-In-One Happy Mat, an integrated bowl and placemat formed of silicone. The EXPZ solution, described in U.S. patent application Ser. No. 14/333,682, emphasizes a flat diffuse surface relying on the surface adhesion of silicone to fix the dinnerware mat combination to a table. Often the EZPZ solution does not provide sufficient surface adhesion allowing the child to successfully demonstrate the immutable force of gravity. Thus, a heretofore unaddressed need exists in the industry to address the aforementioned deficiencies and inadequacies.

### SUMMARY

The present disclosure provides a feeding mat and methods for its use. In one embodiment the feeding mat, suitable for use on a flat surface such as a table, comprises a base having an upper surface, a lower surface, an inner region and an outer region. An outer wall is integrally formed in the upper surface forming a dish suitable to contain a food product. The inner region is essentially planar and forms a reference plane generally parallel to the flat surface. The outer region has a slope with respect to the inner region and reference plane in the range of around 1.0° to 10.0°.

The present disclosure also provides methods for the use of a feeding mat. In this regard, one embodiment of the method comprises the steps of fixing a feeding mat to a flat surface. The feeding mat has a base and a dish. The base has an upper surface, a lower surface, an inner region, an outer region and an outer edge. The inner region is generally parallel with the flat surface and forms a reference plane. The outer region has a slope in the range of around 1.0° to 10.0° with respect to the inner region and reference plane and is bounded by the outer edge. In the first step, the feeding mat is positioned above the flat surface. In the next step, the outer edge of the base is placed on the flat surface to form a cavity with respect to the inner and outer regions of the lower surface. In the next step, the feeding mat is pressed to bring the inner and outer regions of the lower surface toward the flat surface. In the next step, the inner and outer regions of the lower surface contact the flat surface. In the next step, air is expelled from the cavity to create a vacuum seal between the feeding mat and the flat surface. In the final step, the dish formed in the upper surface of the feeding mat is filled with food.

In some embodiments, a feeding mat, suitable for use on a substantially flat surface, comprises: a base comprising an inner region and an outer region, the inner region comprising a first upper surface and a first lower surface, and the outer region comprising a second upper surface and a second lower surface, wherein the first lower surface forms a reference plane substantially parallel to the substantially flat surface, wherein the second lower surface has a first slope with respect to the reference plane before a vacuum seal is created between the first lower surface and the substantially flat surface, and wherein the first lower surface is in direct contact with the substantially flat surface after the vacuum seal is created between the first lower surface and the substantially flat surface; and a dish integrally formed in the first upper surface and defined by an outer wall extending continuously from the first lower surface to the first upper surface, wherein the dish is suitable to contain a food product.

In some embodiments, the slope is approximately 3.0 degrees. In some embodiments, the slope is in a range of approximately 1.0 to 10.0 degrees. In some embodiments, the first lower surface and the second lower surface are parts of a continuous lower surface. In some embodiments, the feeding mat is constructed of thermoplastic or silicone. In some embodiments, a rim is integrally formed in a first outer edge of the second upper surface and extends continuously from the first outer edge of the second upper surface to a second outer edge of the second lower surface. In some embodiments, the dish comprises at least two compartments, and wherein the at least two compartments are separated by one or more side walls. In some embodiments, after the vacuum seal is created, the feeding mat is immovable, thereby enabling consumption of the food product from the dish. In some embodiments, the dish is in direct contact with the food product. In some embodiments, the second upper surface is substantially parallel to the reference plane after the vacuum seal is created between the first lower surface and the substantially flat surface. In some embodiments, the second upper surface has a second slope with respect to the reference plane before the vacuum seal is created between the first lower surface and the substantially flat surface.

In some embodiments, a method is provided for fixing a feeding mat to a substantially flat surface. The method comprises: positioning, on the substantially flat surface, the feeding mat comprising a base and a dish, wherein the base comprises an inner region and an outer region, the inner region comprising a first upper surface and a first lower surface, and the outer region comprising a second upper surface and a second lower surface, wherein the first lower surface forms a reference plane substantially parallel to the substantially flat surface, wherein the second lower surface has a first slope with respect to the reference plane before a vacuum seal is created between the feeding mat and the substantially flat surface, wherein the second lower surface is bounded by a first outer edge, wherein the dish is integrally formed in the first upper surface and defined by an outer wall extending continuously from the first lower surface to the first upper surface, and wherein the dish is suitable to contain a food product; placing the first outer edge on the substantially flat surface to form a cavity bounded by the substantially flat surface, the first lower surface, and the second lower surface; and pressing the feeding mat to bring the first lower surface and the second lower surface toward the substantially flat surface, such that air is expelled from the cavity to create the vacuum seal between the feeding mat and the substantially flat surface, and such that both the first lower surface and the second lower surface contact the substantially flat surface.

In some embodiments, the second upper surface is bounded by a second outer edge, and wherein a bump is formed along a portion of the second outer edge. In some embodiments, the second upper surface has a second slope with respect to the reference plane before the vacuum seal is created between the feeding mat and the substantially flat surface. In some embodiments, the first slope is in a range of approximately 1.0 to 10.0 degrees.

In some embodiments, a feeding mat, suitable for use on a substantially flat surface, comprises: a base comprising an inner region and an outer region, the inner region comprising a first upper surface and a first lower surface, and the outer region comprising a second upper surface and a second lower surface, wherein the second upper surface forms a reference plane substantially parallel to the substantially flat surface, wherein at least a portion of the first lower surface has a first slope with respect to the reference plane before a vacuum seal is created between the first lower surface and the substantially flat surface, wherein at least a portion of the second lower surface has a second slope with respect to the reference plane before the vacuum seal is created between the first lower surface and the substantially flat surface, and wherein the first lower surface is in direct contact with the substantially flat surface after the vacuum seal is created between the first lower surface and the substantially flat surface; and a dish integrally formed in the first upper surface and defined by an outer wall extending continuously from the first lower surface to the first upper surface, wherein the dish is suitable to contain a food product.

In some embodiments, the first slope is in a range of approximately 1.0 to 10.0 degrees. In some embodiments, the first slope is substantially equivalent to the second slope. In some embodiments, the second lower surface is in direct contact with the substantially flat surface after the vacuum seal is created between the first lower surface and the substantially flat surface. In some embodiments, a rim is integrally formed in a first outer edge of the second upper surface and extends continuously from the first outer edge of the second upper surface to a second outer edge of the second lower surface.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a top view of a feeding mat in accordance with one embodiment of the present invention;

FIG. 2 is a cross sectional view of the feeding mat shown in FIG. 1 along the line A-A;

FIG. 3A is another cross sectional view of the feeding mat shown in FIG. 1 along the line A-A and demonstrating method steps in one embodiment of the present invention; and

FIG. 3B is another cross sectional view of the feeding mat shown in FIG. 1 along the line A-A and demonstrating method steps in one embodiment of the present invention.

### DETAILED DESCRIPTION OF THE EMBODIMENTS

Reference is now made in detail to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents.

A feeding mat, suitable for use on a flat surface such as a table, and methods for its use are disclosed. In some embodiments, the feeding mat comprises a base having an upper surface, a lower surface, an inner region and an outer region. In some embodiments, an outer wall is integrally formed in the upper surface forming a dish suitable to contain a food product. In some embodiments, the inner region is essentially planar and forms a reference plane generally parallel to the flat surface. In some embodiments, the outer region has a slope with respect to the inner region and reference plane in the range of around 1.0° to 10.0°.

The present disclosure also provides methods for the use of a feeding mat. In this regard, one embodiment of the method comprises the steps of fixing a feeding mat to a flat surface. The feeding mat has a base and a dish. The base has an upper surface, a lower surface, an inner region and an outer region. The lower surface of the inner region is generally parallel with the upper surface of the inner region and forms a reference plane. The outer region has a slope in the range of around 1.0° to 10.0° with respect to the inner region and reference plane and is bounded by an outer edge. In the first step, the feeding mat is positioned above the flat surface. In the next step, the outer edge of the outer region is placed on the flat surface to form a cavity with respect to the inner and outer regions of the lower surface. In the next step, the feeding mat is pressed to bring the inner and outer regions of the lower surface toward the flat surface. In the next step, the inner and outer regions of the lower surface contact the flat surface. In the next step, air is expelled from the cavity to create a vacuum seal between the feeding mat and the flat surface. In the final step, the dish formed in the upper surface of the feeding mat is filled with food.

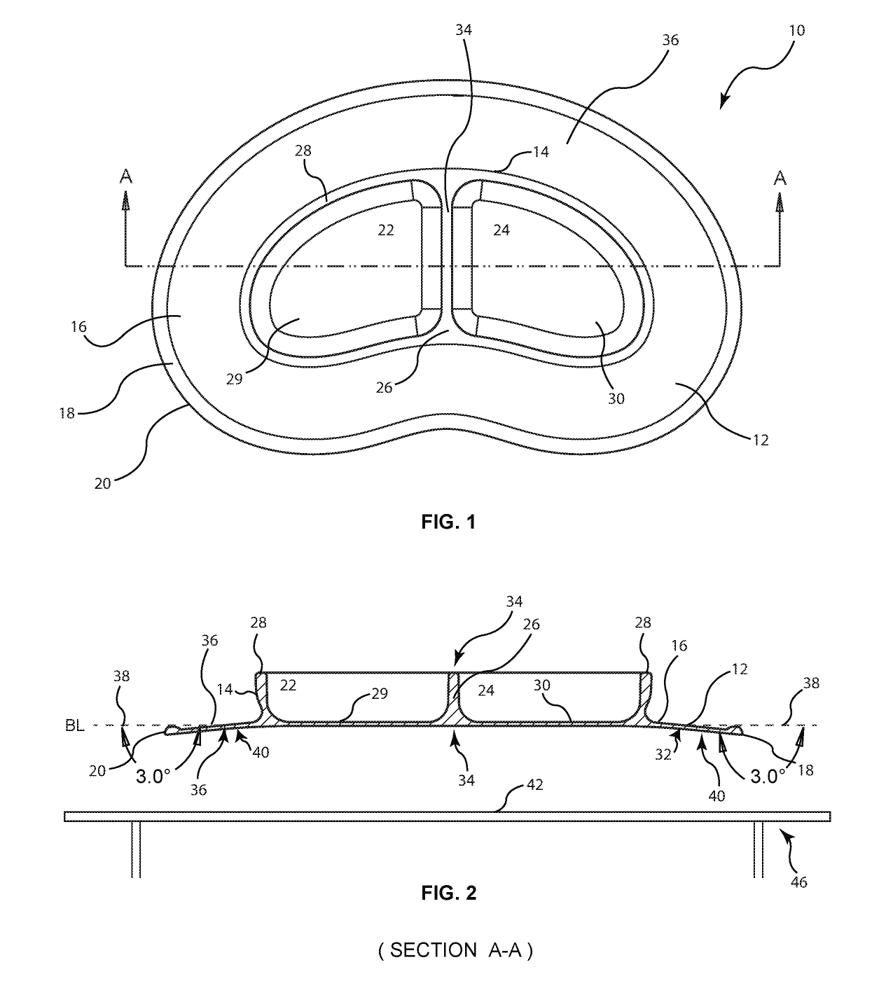

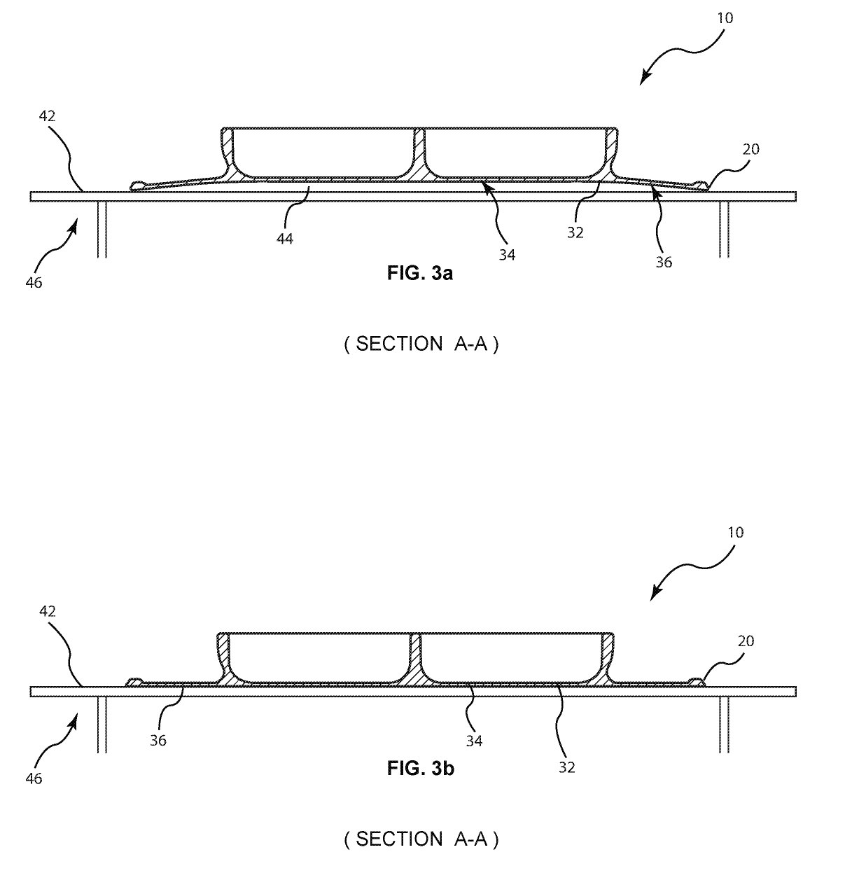

Referring now to FIG. 1, a top view of a feeding mat in accordance with one embodiment of the present invention, feeding mat 10 is comprised of base 12 and dish 14. Base 12, while shown in a “kidney bean” shape can be oval, round, square, rectangular or any other shape that is aesthetically pleasing or that the designer chooses. Dish 14 similarly can either match the outline of base 12 or be formed into other shapes. Dish 14 is suitable for containing food products and can also be formed as any type of dinnerware such as a plate, bowl or other container adapted for holding food items. Base 12 has an upper surface 16, a lower surface 32 shown in FIGS. 2, 3A and 3B, an inner region 34, an outer region 36 and a rim 18 along outer edge 20. Dish 14 is defined by outer wall 28 and can have separate compartments 22 and 24 separated by side wall 26. Compartments 22 and 24 are formed by outer wall 28, sidewall 26 and have bottoms 29 and 30 making them suitable for holding food items. As shown in FIGS. 2, 3A and 3B, feeding mat 10 is intended for use on a flat surface 42, such as a table 46, but will also adhere to surfaces that are not entirely flat. In a preferred embodiment, inner region 34 is planar or flat so that when feeding mat 10 is placed on a table 46 it is generally parallel to the flat surface 42.

Referring now to FIG. 2, a cross sectional view of the of the feeding mat shown in FIG. 1 along the line A-A, feeding mat 10 is shown as a single or integrated piece formed of a thermoplastic such as silicone. In the preferred embodiment, New Orient Brand ZY-4452 silicone is used in a conventional molding process well known to those skilled in the art. Still referring to FIG. 2, base 12 has an upper surface 16 and lower surface 32. In a preferred embodiment, polishing lower surface 32 of base 12 to form a polished surface, as is well known to those skilled in the art, is found to improve the adherence of feeding mat 10 to a flat or other surface 42. Base 12 also has inner region 34 and outer region 36. The inner region 34 is essentially planar and generally parallel to flat surface 42 and forms a base line (BL) or reference plane 38 also essentially parallel to flat surface 42. Outer region 36 has a slope 40 that in the preferred embodiment is pitched at an angle of 3.0° with respect to base line or reference plane 38. While in the preferred embodiment the angle of slope 40 is approximately 3.0°, a pitch in the range of around 1.0° to 10.0° is within the scope of the invention and does not depart materially from the preferred embodiment. FIG. 2 also illustrates a first step of an embodiment of a method in accordance with the present invention by positioning feeding mat 10 above flat surface 42.

Referring now to FIG. 3A, another cross sectional view of the feeding mat shown in FIG. 1 along the line A-A and demonstrating method steps in one embodiment of the present invention, outer edge 20 of feeding mat 10 is placed on a flat surface 42 and forms a cavity 44. The boundaries of cavity 44 are defined by outer edge 20, inner and outer regions 34 and 36 of lower surface 32, and flat surface 42. In the next step feeding mat 10 is pressed to bring inner and outer regions 34 and 36 toward flat surface 42.

Referring now to FIG. 3B, another cross sectional view of the feeding mat shown in FIG. 1 along the line A-A and demonstrating method steps in one embodiment of the present invention, inner and outer regions 34 and 36 of lower surface 32 contact flat surface 42. As inner and outer regions 34 and 36 of lower surface 32 are brought into contact with flat surface 42, air trapped in cavity 44 is expelled creating a vacuum seal between feeding mat 10 and flat surface 42.

In another embodiment, slope 40 is imposed over the entire lower surface 32. In this embodiment, the upper surface 16 of base 12 is essentially flat and parallel to flat surface 42 of table 46. Lower surface 32 of base 12 has a slope, relative to upper surface 16, originating at inner region 34 and sloping outward toward outer edge 20. In this embodiment, slope 40 can be in the range of 1.0° to 10.0° and preferably is 3.0°. It should also be understood that slope 40 can originate at other locations on lower surface 32. So it is contemplated within the scope of the present invention that a portion of lower surface 32 may be flat and parallel to upper surface 16 while another portion of lower surface 32 has a slope.

The present disclosure also provides methods for the use of a feeding mat. In this regard, one embodiment of the method comprises the steps of fixing a feeding mat 10 to a flat surface 42. The feeding mat has a base 12 and a dish 14. Base 12 has an upper surface 16, a lower surface 32, an inner region 34 and an outer region 36. The inner region 34 of lower surface 32 is generally parallel with the flat surface 42 and forms a reference plane 38. The inner region has a slope 40 in the range of around 1.0° to 10.0° with respect to reference plane 38 and is bounded by an outer edge 20. In the first step, the feeding mat 10 is positioned above the flat surface 42. In the next step, the outer edge 20 of the outer region 36 is placed on the flat surface 42 to form a cavity 44 with respect to the inner and outer regions 34 and 36 of the lower surface 32. In the next step, the feeding mat 10 is pressed to bring the inner and outer regions 34 and 36 of the lower surface 32 toward the flat table surface. In the next step, the inner and outer regions 34 and 36 of the lower surface 32 contact the flat surface 42. In the next step, air is expelled from the cavity 44 to create a vacuum seal between the feeding mat 10 and the flat surface 42. In the final step, the dish 14 formed on the upper surface 16 of the feeding mat 10 is filled with food.

In some embodiments, a feeding mat suitable for use on a flat surface such as a table, comprises: a base having an upper surface, a lower surface, an inner region and an outer region; an outer wall integrally formed in the upper surface forming a dish suitable to contain a food product; the inner region being essentially planar and forming a reference plane parallel to the flat surface; and the outer region having a slope with respect to the inner region. In some embodiments, the slope is about 3.0 degrees. In some embodiments, the slope is in the range of approximately 1.0 to 10.0 degrees. In some embodiments, the lower surface is a polished surface. In some embodiments, the feeding mat is constructed of a thermoplastic. In some embodiments, the thermoplastic is silicone. In some embodiments, the dish is further divided having one or more side walls.

In some embodiments, a method is provided for fixing a feeding mat to a flat surface. The method comprises positioning above the flat surface the feeding mat having a base and a dish, the base having an upper surface, a lower surface, an inner region and an outer region, the inner region forming a reference plane, the outer region having a slope with respect to the reference plane and bounded by an outer edge; placing the outer edge of the outer region on the flat surface to form a cavity with respect to the inner and outer regions of the lower surface; pressing the feeding mat to bring the inner and outer regions of the lower surface toward the flat surface; contacting the inner and outer regions of the lower surface to the flat surface; expelling air from the cavity to create a vacuum seal between the feeding mat and the flat surface; and filling a dish formed in an upper surface of the feeding mat with food. In some embodiments, the feeding mat is constructed of silicone. In some embodiments, the lower surface is a polished surface. In some embodiments, the dish is divided into two or more compartments. In some embodiments, the slope is about 3.0 degrees. In some embodiments, the slope is in the range of 1.0 to 10.0 degrees.

In some embodiments, a feeding mat, suitable for use on a flat surface, comprises: a base having an upper surface, a lower surface, an inner region and an outer region, the outer region being bounded by an outer edge; an outer wall, integrally formed above the upper surface, forming a dish suitable to contain a food product; the inner region being essentially planar with the flat surface and forming a reference plane generally parallel to the flat surface; and the outer region having a slope with respect to the inner region. In some embodiments, the slope is about 3.0 degrees. In some embodiments, the slope is in the range of 1.0 to 10.0 degrees. In some embodiments, the lower surface is a polished surface. In some embodiments, the feeding mat is constructed of silicone. In some embodiments, the outer edge forms a rim. In some embodiments, the dish is further divided having one or more side walls.

Although exemplary embodiments have been shown and described, it will be clear to those of ordinary skill in the art that a number of changes, modifications, or alterations to the disclosure as described may be made. For example, base 12 and dish 14 can be made in any shape. Dish 14 can be any style of dinnerware such as a bowl or plate and have either a single or multiple compartments. The angle of slope 40 can be varied within the range of around 1.0° to 10.0° below a base line or reference plane. All such changes, modifications, and alterations should therefore be seen as within the scope of the disclosure.

What is claimed is:

1. A feeding mat, suitable for use on a substantially flat surface, comprising:
a base comprising an inner region and an outer region, the inner region comprising a first upper surface and a first lower surface, and the outer region comprising a second upper surface and a second lower surface,
wherein the first lower surface forms a reference plane substantially parallel to the substantially flat surface,
wherein the second lower surface has a first slope with respect to the reference plane before a vacuum seal is created between the first lower surface and the substantially flat surface, and
wherein the first lower surface is in direct contact with the substantially flat surface after the vacuum seal is created between the first lower surface and the substantially flat surface; and
a dish integrally formed in the first upper surface and defined by an outer wall extending continuously from the first lower surface to the first upper surface, wherein the dish is suitable to contain a food product.

2. The feeding mat of claim 1, wherein the slope is approximately 3.0 degrees.

3. The feeding mat of claim 1, wherein the slope is in a range of approximately 1.0 to 10.0 degrees.

4. The feeding mat of claim 1, wherein the first lower surface and the second lower surface are parts of a continuous lower surface.

5. The feeding mat of claim 1, wherein the feeding mat is constructed of thermoplastic or silicone.

6. The feeding mat of claim 1, wherein a rim is integrally formed in a first outer edge of the second upper surface and extends continuously from the first outer edge of the second upper surface to a second outer edge of the second lower surface.

7. The feeding mat of claim 1, wherein the dish comprises at least two compartments, and wherein the at least two compartments are separated by one or more side walls.

8. The feeding mat of claim 1, wherein after the vacuum seal is created, the feeding mat is immovable, thereby enabling consumption of the food product from the dish.

9. The feeding mat of claim 1, wherein the dish is in direct contact with the food product.

10. The feeding mat of claim 1, wherein the second upper surface is substantially parallel to the reference plane after the vacuum seal is created between the first lower surface and the substantially flat surface.

11. The feeding mat of claim 1, wherein the second upper surface has a second slope with respect to the reference plane before the vacuum seal is created between the first lower surface and the substantially flat surface.

12. A method of fixing a feeding mat to a substantially flat surface comprising:
positioning, on the substantially flat surface, the feeding mat comprising a base and a dish,
wherein the base comprises an inner region and an outer region, the inner region comprising a first upper surface and a first lower surface, and the outer region comprising a second upper surface and a second lower surface,
wherein the first lower surface forms a reference plane substantially parallel to the substantially flat surface,
wherein the second lower surface has a first slope with respect to the reference plane before a vacuum seal is created between the feeding mat and the substantially flat surface,
wherein the second lower surface is bounded by a first outer edge,
wherein the dish is integrally formed in the first upper surface and defined by an outer wall extending continuously from the first lower surface to the first upper surface, and
wherein the dish is suitable to contain a food product;
placing the first outer edge on the substantially flat surface to form a cavity bounded by the substantially flat surface, the first lower surface, and the second lower surface; and
pressing the feeding mat to bring the first lower surface and the second lower surface toward the substantially flat surface, such that air is expelled from the cavity to create the vacuum seal between the feeding mat and the substantially flat surface, and such that both the first lower surface and the second lower surface contact the substantially flat surface.

13. The method of claim 12, wherein the second upper surface is bounded by a second outer edge, and wherein a bump is formed along a portion of the second outer edge.

14. The method of claim 12, wherein the second upper surface has a second slope with respect to the reference plane before the vacuum seal is created between the feeding mat and the substantially flat surface.

15. The method of claim 12, wherein the first slope is in a range of approximately 1.0 to 10.0 degrees.

16. A feeding mat, suitable for use on a substantially flat surface, comprising:
a base comprising an inner region and an outer region, the inner region comprising a first upper surface and a first lower surface, and the outer region comprising a second upper surface and a second lower surface,
wherein the second upper surface forms a reference plane substantially parallel to the substantially flat surface,
wherein at least a portion of the first lower surface has a first slope with respect to the reference plane before a vacuum seal is created between the first lower surface and the substantially flat surface,
wherein at least a portion of the second lower surface has a second slope with respect to the reference plane before the vacuum seal is created between the first lower surface and the substantially flat surface, and
wherein the first lower surface is in direct contact with the substantially flat surface after the vacuum seal is created between the first lower surface and the substantially flat surface; and
a dish integrally formed in the first upper surface and defined by an outer wall extending continuously from the first lower surface to the first upper surface, wherein the dish is suitable to contain a food product.

17. The feeding mat of claim 16, wherein the first slope is in a range of approximately 1.0 to 10.0 degrees.

18. The feeding mat of claim 16, wherein the first slope is substantially equivalent to the second slope.

19. The feeding mat of claim 16, wherein the second lower surface is in direct contact with the substantially flat surface after the vacuum seal is created between the first lower surface and the substantially flat surface.

20. The feeding mat of claim 16, wherein a rim is integrally formed in a first outer edge of the second upper surface and extends continuously from the first outer edge of the second upper surface to a second outer edge of the second lower surface.
